(19) United States
(12) Patent Application Publication
(10) Pub. No.: US 2005/0046736 A1
(43) Pub. Date: Mar. 3, 2005

(54) Imaging device and portable equipment

(76) Inventor: Toru Kuchimaru, Toyokawa-shi (JP)

Correspondence Address: Brinks Hofer Gilson & Lione, P.O. Box 10395, Chicago, IL, 60610, US

(21) Appl. No.: 10/738,450

(22) Filed: Dec. 17, 2003

(30) Foreign Application Priority Data
Aug. 29, 2003 (JP) 2003-306363

(51) Int. Cl. H04N 5/225; H04N 5/232

(52) U.S. Cl. 348/340; 348/345

(57) ABSTRACT

The present invention provides an imaging device that is possible to conduct a focus adjustment with a high degree of accuracy due to high accurate fit between a hanger shaft and a hanger shaft hole of a lens frame. The imaging device 1 has an imaging unit 2, an optical unit 4 comprising a lens 16 and a lens frame 17 which supports the lens 16 and has a hanger shaft hole 19, a chassis 3 on which a hanger shaft 12 is integrally formed to fit into the hanger shaft hole 19, and a drive unit 5 for actuating the lens frame 17 of the optical unit 4 in an optical axis direction. The hanger shaft 12 has a plurality of diameters d₁, d₂ so that the chassis side of the hanger shaft 12 is largest and the side apart from the chassis 3 becomes small. The hanger shaft hole 19 has a plurality of diameters d₃, d₄ which fit to the hanger shaft 12.

This application is based on an application No. 2003-306363 filed in Japan, the contents of which is hereby incorporated by reference.

### BACKGROUND OF THE INVENTION

The present invention relates to an imaging device installed in portable equipment such as mobile phone, PHS (Personal Handy-phone System), PDA (Personal Digital Assistant), and mobile personal computer, surveillance camera, and the like. The present invention also relates to a portable equipment utilizing the imaging device.

In recent years, mobile phones and the like having a camera installed therein have become pervasive. There has been a trend for imagers to have greater number of pixels in cameras installed in mobile phones, three hundred and ten thousand pixels has been common nowadays, and one million pixels has become commercially practical. As imaging units that include such imagers with high pixel densities, those with sizes not larger than 10 mm in length of one side (in rectangular shapes) have been developed. On the other hand, lenses of such cameras have been miniaturized so as to have sizes the same as or smaller than the imaging units have.

In the Japanese Patent Laid-Open Publication 2002-139662 has been proposed a miniature imaging device that is composed of an imaging unit and a lens part and that is suitable for mobile phone. In the imaging device, degrees of freedom of aberration correction are increased by use of two lenses in the lens part. Besides, a necessity for focusing adjustment for the two lenses is eliminated by positioning, with respect to the imaging unit, of a square-pipe-like first supporting member with which a first lens has been formed integrally and by positioning, with respect to the first supporting member, of a second supporting member in which a second lens has been installed.

Imagers with high pixel densities, however, require focusing and thus require a drive unit for moving the lenses in a direction of an optical axis for the focusing. Provision of such a drive unit involves a large camera unit and makes it difficult to install the unit in mobile phones and the like.

In an imaging device of a type that a lens frame supporting a lens is slidably supported by a hanger shaft in an optical direction, even the imager or the lens were miniaturized, there has been a limit of manufacturing the hanger shaft and hanger shaft hole with a high degree of accuracy. Especially, in a imaging device having an imaging unit having a side of not more than 10 mm, it is difficult to satisfy an inclination accuracy of the hanger shaft and a fit accuracy between the hanger shaft and the hanger shaft hole.

### SUMMARY OF THE INVENTION

The present invention has been made in consideration of the problems of the prior art and an object of the invention is to provide an imaging device that is possible to conduct a focus adjustment with a high degree of accuracy due to high accurate fit between a hanger shaft and a hanger shaft hole of a lens frame.

In order to achieve the object, the present invention provides an imaging device comprising:
an imaging unit having a photoelectric converter for converting an optical image into electric signal;
an optical unit for forming an optical image of a subject on the photoelectric converter, the optical unit comprising a lens and a lens frame which supports the lens and has a hanger shaft hole;
a chassis on which the imaging unit is mounted and a hanger shaft is integrally formed, the hanger shaft being fit into the hanger shaft hole to support the lens frame so that the lens frame is capable of moving in an optical axis direction; and
a drive unit for actuating the lens frame of the optical unit in the optical axis direction, and
wherein the hanger shaft has a plurality of diameters so that the chassis side of the hanger shaft is largest and the side apart from the chassis becomes small, and
wherein the hanger shaft hole has a plurality of diameters which fit to the hanger shaft.

In accordance with the invention, it is easy to strip a mold when molding the hanger shaft and the hanger shaft hole of the lens frame. Because of high accuracy of fit between the hanger shaft and the hanger shaft hole of the lens frame, it is also possible to conduct a focus adjustment with a high degree of accuracy. As the hanger shaft is integrally formed on the chassis, it has a good inclination accuracy.

The present invention further provides a portable equipment such as a mobile phone, PHS, PDA, and mobile personal computer, surveillance camera, and the like comprising the aforementioned imaging device.

### BRIEF DESCRIPTION OF THE DRAWINGS

Further objects and advantages of the present invention will become clear from the following description taken in conjunction with the preferred embodiments thereof with reference to the accompanying drawings, in which:

FIG. 1 is an exploded perspective view of an imaging device in accordance with a first embodiment of the invention;

FIG. 2 is a front view of the imaging device of FIG. 1;

FIG. 3 is a right side view, partly in section, of the imaging device of FIG. 2;

FIG. 4 is a view, partly in section, showing a relation between a hanger shaft and a hanger shaft hole;

FIGS. 5A and 5B are enlarged views showing fitting states of the hanger shaft and the hanger shaft hole;

FIG. 6 is a view, partly in section, of a variation of FIG. 4 showing a relation between a hanger shaft and a hanger shaft hole;

FIG. 7 is a view, partly in section, of an another variation of FIG. 4 showing a relation between a hanger shaft and a hanger shaft hole;

FIG. 8 is a front view illustrating a modification of the imaging device of FIG. 2;

FIG. 9 is a front view illustrating another modification of the imaging device of FIG. 2;

FIGS. 10A, 10B and 10C are a front view, right side view, partly in section, and back side view, respectively, of a mobile phone with a built-in camera having the imaging device of FIGS. 1-3; and

FIG. 11 is a functional block diagram illustrating a construction of control system of the mobile phone of FIGS. 10A, 10B and 10C.

### DETAILED DESCRIPTION OF THE PREFERRED EMBODIMENTS

Hereinbelow, embodiments of the invention will be described with reference to the accompanying drawings.

### Embodiment of Imaging Device

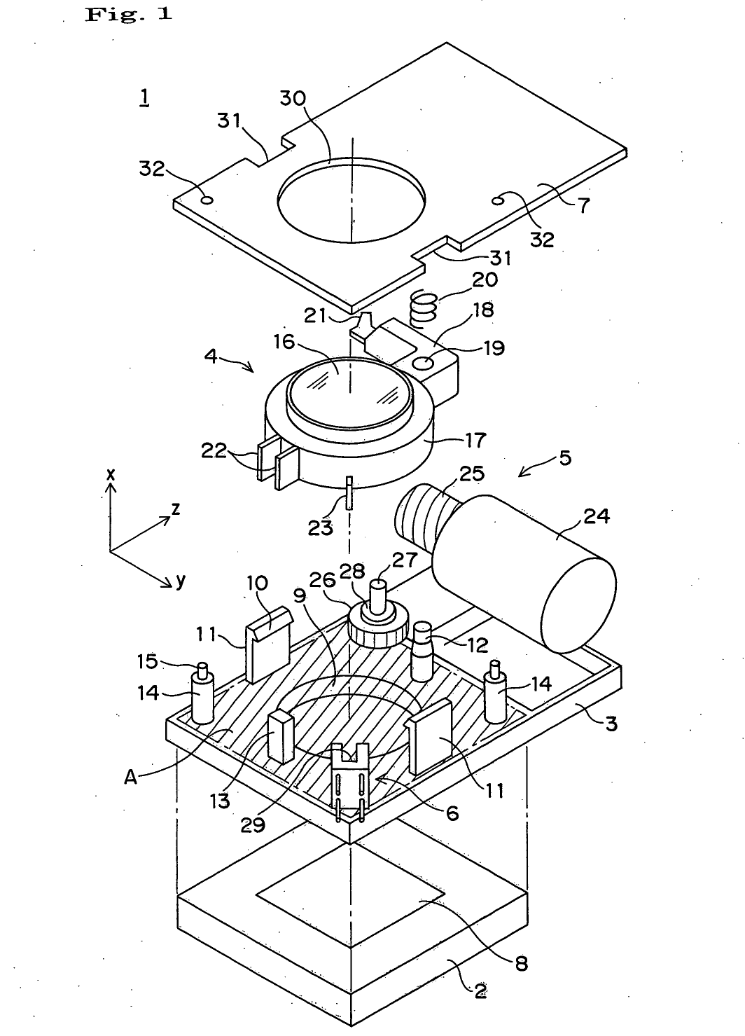

FIGS. 1 through 3 show an imaging device 1 in accordance with a first embodiment of the invention. The imaging device 1 is composed of an imaging unit 2, a chassis 3, an optical unit 4, a drive unit 5, a detector 6, and a cover 7.

The imaging unit 2 has a rectangular shape and includes a photoelectric converter 8 composed of, for example, a CCD sensor or a CMOS sensor at a center thereof. The imaging unit 2 is mounted on a control substrate not shown. Lengths of sides of the imaging unit 2 are on the order of 10 mm. The shape of the imaging unit 2 is not limited to such a rectangular one as in the embodiment but circular or other shapes may be employed.

The chassis 3 is a base on which the units of the imaging device 1 are to be mounted, and has a rectangular shape having sides substantially as long as those of the imaging unit 2 and having the remaining sides longer than those of the imaging unit 2. On a back of the chassis 3 is mounted the imaging unit 2. An aperture 9 is formed in the chassis 3, and a central axis of the photoelectric converter 8 of the imaging unit 2 is positioned so as to extend through a center of the aperture 9 in a direction perpendicular to a surface of the chassis 3 (which direction will be referred to as optical axis direction or as x direction, hereinbelow).

A pair of elastic pieces 11 having hooks 10 at extremities thereof are arranged along a direction extending through the center of the aperture 9 in parallel with the shorter sides of the chassis 3 (which direction will be referred to as y direction, hereinbelow) and protrude on both sides of the aperture 9. A cylindrical hanger shaft 12 and a rectangular-prism-like guide 13 are arranged along a direction extending through the center of the aperture 9 in parallel with the longer sides of the chassis 3 (which direction will be referred to as z direction, hereinbelow) and protrude on both sides of the aperture 9. A pair of pillars 14 that support a cover 7 are provided so as to protrude on corners on one diagonal line extending through the center of the aperture 9. A pin 15 protrudes from an extremity of each pillar 14. A cam gear 26 of the drive unit 5 and the detector 6, which will be described later, are mounted on corners on the other diagonal line extending through the center of the aperture 9.

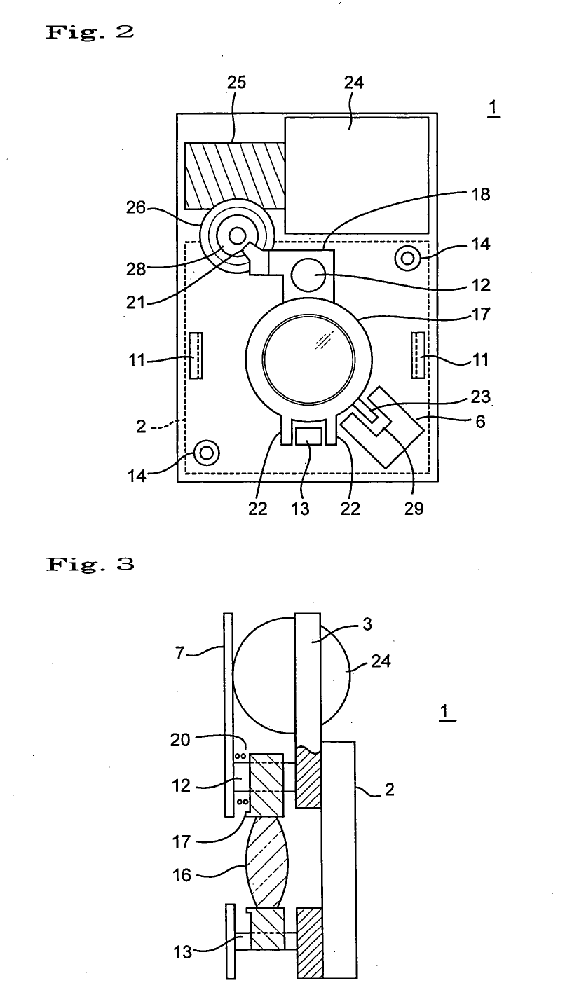

The pair of elastic pieces 11, the hanger shaft 12, the guide 13, the pair of pillars 14, and the detector 6 on the chassis 3 are provided in a projected area A of the imaging unit 2 in the optical axis direction which area is diagonally shaded in FIG. 1. Similarly, part (half, in the embodiment) of the cam gear 26 is provided in the projected area A of the imaging unit 2 in the optical axis direction. A length in y direction of the drive unit 5 including a motor. 24 and a worm gear 25 is substantially the same as a width in y direction of the imaging unit 2, as shown in FIG. 2, and a thickness in the optical axis direction of the drive unit 5 including the motor 24 is substantially the same as an overall thickness in the optical axis direction of the imaging device 1, as shown in FIG. 3.

The optical unit 4 is composed of a lens frame 17 that supports a lens 16. A protrusion 18 bent to an angle of 90° is integrally provided on a z-direction end of an outer circumferential surface of the lens frame 17, and a hanger shaft hole 19 is formed in the protrusion 18 so as to extend in parallel with the optical axis. The lens frame. 17 is biased by a spring 20 in a direction nearing the imaging unit 2, with the hanger shaft 12 on the chassis 3 fit in the hanger shaft hole 19 and capable of sliding in the optical axis direction. A projection-like cam follower 21 is formed at an extremity of the protrusion 18. A pair of guide pieces 22 between which the guide 13 on the chassis 3 is fitted are provided on the outer circumferential surface of the lens frame. 17 on a side opposite to the protrusion 18. Furthermore, a piece 23 that is to be detected by the detector 6 on the chassis 3 is provided on the outer circumferential surface of the lens frame 17.

The drive unit 5 is composed of the motor 24, the worm gear 25 as a driving gear fixed to a drive shaft of the motor 24, and the cam gear 26. The motor 24 is mounted on the chassis 3 so that the drive shaft is perpendicular to the optical axis. The cam gear 26 is mounted on the chassis 3 so that the cam gear 26 meshes with the worm gear 25 and so that a shaft 27 of the cam gear 26 is made perpendicular to the drive shaft of the motor 24. The cam gear 26 has a cam surface 28 inclined with respect to the shaft 27. The cam follower 21 of the lens frame 17 is in slidable pressure contact with the cam surface 28.

The detector 6 has a slot 29 that faces the lens frame 17 and that parallels the optical axis, and light emitting elements and light receiving elements that are not shown are provided on opposed walls of the slot 29. The piece 23 to be detected on the lens frame 17 is fitted into the slot 29 of the detector 6. When the lens frame 17 moves in the optical axis direction, light from the light emitting elements is intercepted by the piece 23 to be detected, at substantially midpoint of a moving range of the frame, and a position of the lens frame 17 with respect to the optical axis direction is thereby detected.

The cover 7 covers a front of the chassis 3, and has a rectangular shape substantially the same as the chassis 3 has. The cover 7 has an aperture 30 that faces the lens frame 17. On both sides of the aperture 30 are formed cutouts 31 in which the hooks 10 of the pair of elastic pieces 11 on the chassis 3 are to be engaged. On a diagonal line extending through a center of the aperture 30 are formed pin holes 32 into which the pins 15 at the extremities of the pillars 14 on the chassis 3 are to be fitted. After the pins 15 at the extremities of the pillars 14 on the chassis 3 are fitted into the pin holes 32, the cover 7 is fixed by welding of the pins 15.

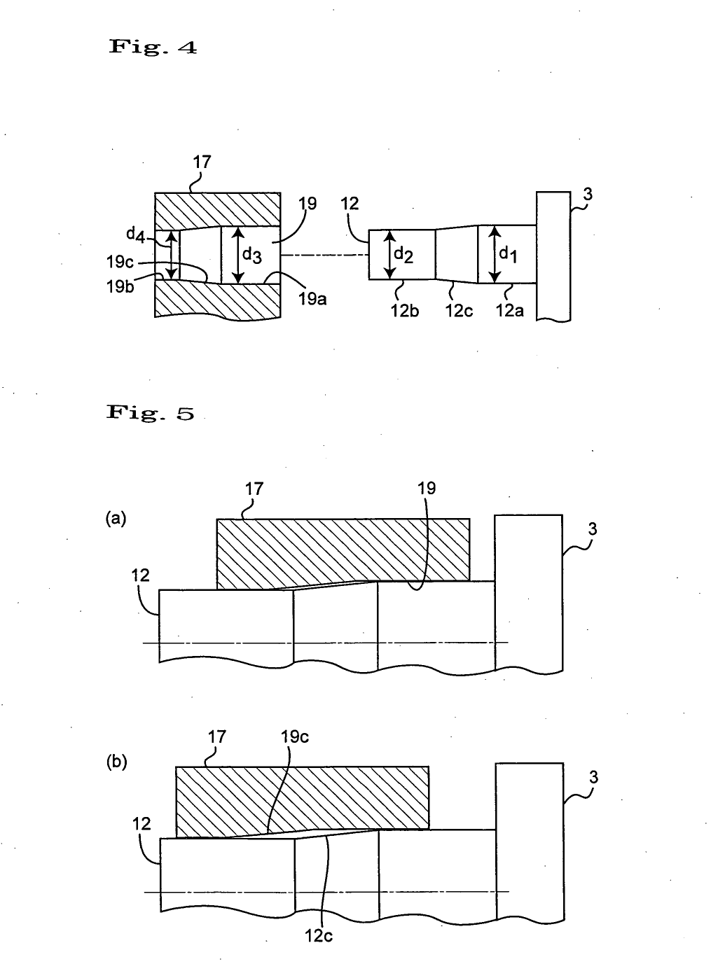

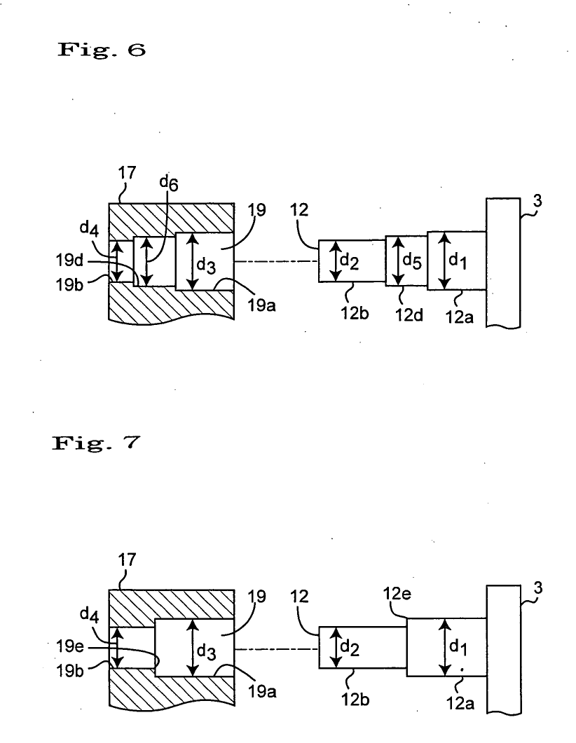

FIG. 4 shows a relation between the hanger shaft 12 of the chassis 3 and the hanger shaft hole 19 of the lens frame 17 of the optical unit 4. The hanger shaft 12 is integrally formed on the chassis 3 made of resin (engineering plastic). This ensures an inclination of the hanger shaft 12 with respect to the chassis 3 and secures a high accuracy of the inclination. The hanger shaft 12 comprises a proximal shaft portion 12a having a first diameter (d₁) positioned on the chassis side, a distal shaft portion 12b having a second diameter (d₂) smaller than the first diameter (d₁) positioned on the distal side, and a tapered intermediate shaft portion 12c positioned between the proximal shaft portion 12a and the distal shaft portion 12b. The tapered intermediate shaft portion 12c gives a draft angle when molding the hanger shaft 12, making it easy to strip a mold.

On the other hand, the hanger shaft hole 19 comprises an inlet hole portion 19a having a third diameter (d₃) positioned on the chassis side, an outlet hole portion 19b having a fourth diameter (d₄) smaller than the third diameter (d₃) positioned on the cover side, and a tapered intermediate hole portion 19c positioned between the inlet hole portion 19a and the outlet hole portion 19b. Thus, in the similar way to the hanger shaft 12, the tapered hole portion 19c gives a draft angle when molding the hanger shaft hole 19, making it easy to strip a mold. The third diameter (d₃) of the inlet hole portion 19a has a fit relation to the first diameter (d₁) of the proximal shaft portion 12a of the hanger shaft 12, while the fourth diameter (d₄) of the outlet hole portion 19b has a fit relation to the second diameter (d₂) of the distal shaft portion 12b of the hanger shaft 12. The lens frame 17, therefore, can fit into the hanger shaft 12 without inclination with a high degree of accuracy so that the lens frame 17 can slide in the optical direction as shown in FIG. 5A, allowing focus adjustment to be conducted with a high degree of accuracy. When the lens frame 17 moves from a condition shown in FIG. 5A that the lens frame 17 is close to the chassis 3 to a direction away from the chassis 3, the intermediate hole portion 19c of the lens frame 17 moves away from the intermediate shaft portion 12c as shown in FIG. 5B.

In a variation of the shapes of the hanger shaft 12 and the hanger shaft hole 19, in stead of the tapered intermediate shaft portion 12c and the intermediate hole portion 19c of FIG. 4, the hanger shaft 12 may be formed with a straight intermediate shaft portion 12d having a fifth diameter (d₅) smaller than the first diameter (d₁) and larger than the second diameter (d₂), while the hanger shaft hole 19 may also be formed with a straight intermediate shaft portion 19d having a sixth diameter (d₆) smaller than the third diameter (d₃) and larger than the fourth diameter (d₄).

In an another variation of the shapes of the hanger shaft 12 and the hanger shaft hole 19, removing the tapered intermediate shaft portion 12c and the tapered intermediate hole portion 19c of FIG. 4, the hanger shaft 12 may be formed with a step 12e between the proximal shaft portion 12a and the distal shaft portion 12b, while the hanger shaft hole portion 19 may also be formed with a step 19e between the inlet shaft portion 19a and the outlet shaft portion 19b.

In the above variations, it is also possible to strip a mold and conduct a focus adjustment with a high degree of accuracy.

Hereinbelow, operations of the imaging device having the above configuration will be described with reference to FIGS. 1-3 again.

The imaging device 1 is installed in portable equipment such as mobile phone, together with a control substrate not shown, and thus functions as a camera. When the lens 16 in the lens frame 17 is directed toward a subject, light incident from the subject onto the lens 16 is imaged on the photoelectric converter 8 of the imaging unit 2. The photoelectric converter 8 converts the image of the subject into electric signal and outputs the signal on a liquid crystal display not shown. The image of the subject is thus displayed on the display. Upon a press on a shutter, the image is recorded in memory.

In the imaging device 1, as will be described below, focusing adjustment, or focusing can be performed by movement of the optical unit 4 in the optical axis direction in accordance with a distance to the subject. Rotation of the worm gear 25 with forward operation of the motor 24 in the drive unit 5 causes rotation of the cam gear 26. The cam follower 21 of the lens frame 17 that is in press contact with the cam surface 28 of the cam gear 26 is thus pressed by the cam surface 28 and the optical unit 4 consequently moves toward the subject in the optical axis direction against a biasing force of the spring 20. In this operation, the motor 24 is stopped when the piece 23 to be detected on the lens frame 17 intercepts light traveling from the light emitting elements to the light receiving elements in the detector 6. The focusing (in macro mode) on a near subject is thereby terminated.

With reverse operation of the motor 24, subsequently, the cam follower 21 of the lens frame 17 that is in press contact with the cam surface 28 of the cam gear 26 follows the cam surface 28 and moves toward the imaging unit 2 in the optical axis direction by the biasing force of the spring 20. In this operation, the motor 24 is stopped when the piece 23 to be detected on the lens frame 17 gets out of an optical path of the light traveling from the light emitting elements to the light receiving elements in the detector 6. The focusing (in standard mode) on a standard subject is thereby terminated.

Provision of multi-step cam surfaces 28 and of a plurality of sensors in the detector 6 makes it possible to perform multi-valued focusing with two or more values other than standard and macro modes. In such a configuration, automatic focusing can be performed in which a change in image contrast caused by focusing is detected from picture signal from the imager. By a similar mechanism with use of an optical unit composed of a plurality of lens groups (lens frames), focusing can be performed with movement of one lens group (lens frame) or zooming can be performed with movement of a plurality of lens groups.

In the imaging device 1, as described above, the part of the cam gear 26 of the drive unit 5, the hanger shaft 12, the guide 13, the pair of elastic pieces 11, the pair of pillars 14, and the detector 6 are all provided in the projected area A of the imaging unit 2 in the optical axis direction which area is diagonally shaded in the drawing. The imaging device 1 with this configuration is substantially as large as the imaging unit 2 and is thus miniaturized despite of having the drive unit 5. Therefore, the imaging device 1 is miniaturized as a whole with miniaturization of the imaging unit 2 because the length in y direction of the drive unit 5 is substantially the same as the width in y direction of the imaging unit 2, and because the thickness in the optical axis direction of the drive unit 5 is substantially the same as the overall thickness in the optical axis direction of the imaging device 1.

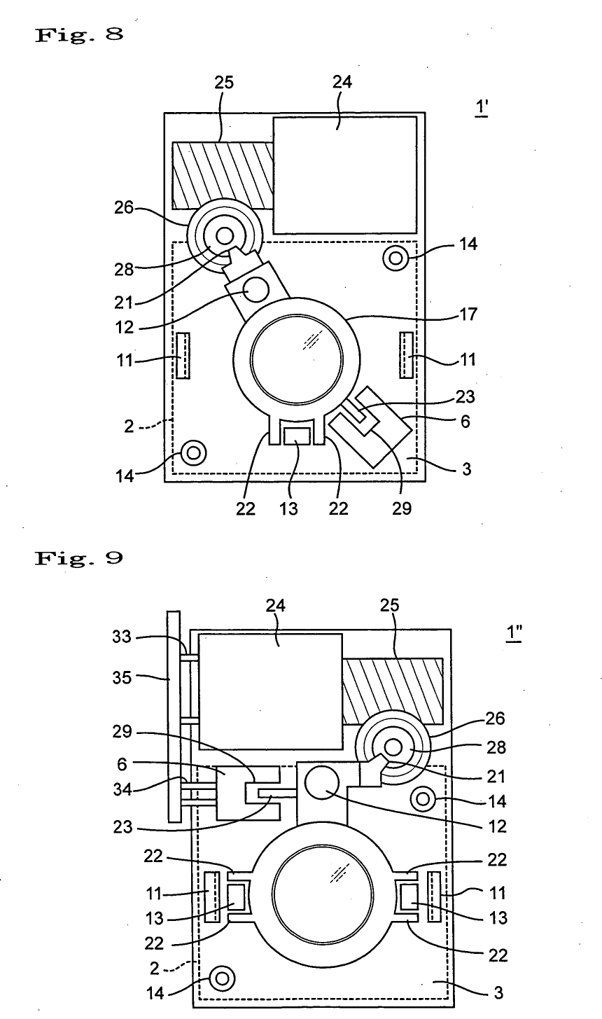

FIG. 8 shows an imaging device 1′ in accordance with a modification of the first embodiment. In the imaging device 1′, a hanger shaft 12 is provided on a corner of a rectangular projected area A, i.e., on a line extending between a cam gear 26 and an optical center of a lens frame 17, so that effective use is made of a wide space on the corner.

FIG. 9 shows an imaging device 1″ in accordance with another modification of the first embodiment. In the imaging device 1″, a motor 24 is positioned in an orientation opposite to the first embodiment so that terminals 33 are positioned on left side as seen looking from a subject. Accordingly, a cam gear 26 is positioned on right side as seen looking from a subject, in contrast to the first embodiment. A detector 6 is provided so as to adjoin the motor 24 and so that terminals 34 protrude on the same side as the terminals of the motor 24. Since the terminals 33 and 34 of the motor 24 and the detector 6 have the same orientation, interconnections can easily be provided and, for example, a board 35 can directly be mounted. On both sides of a lens frame 17 are provided a pair of guides 13.

### Embodiment of Mobile Phone

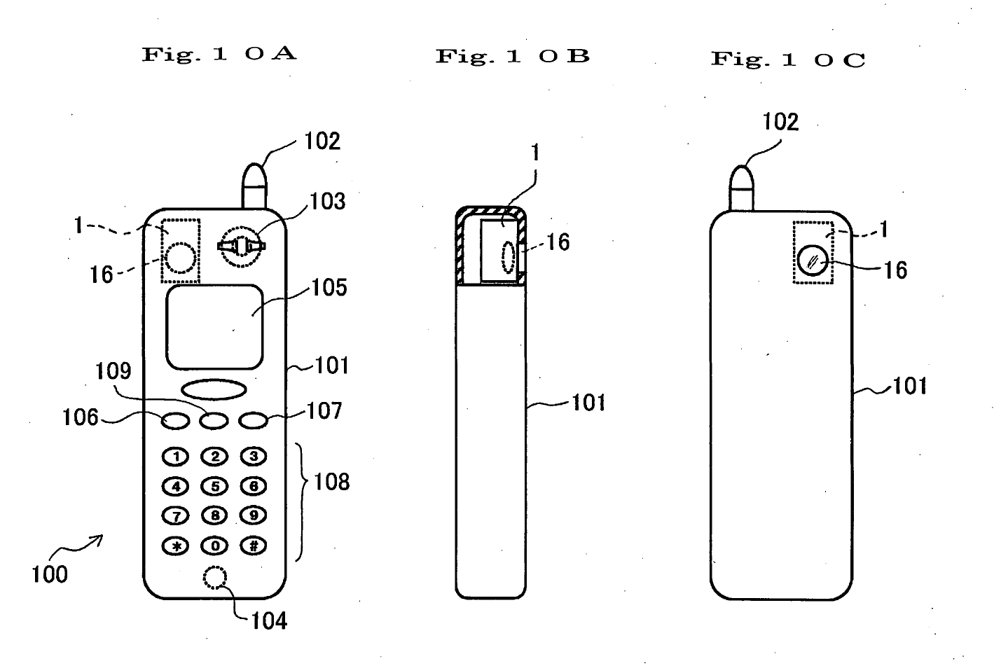

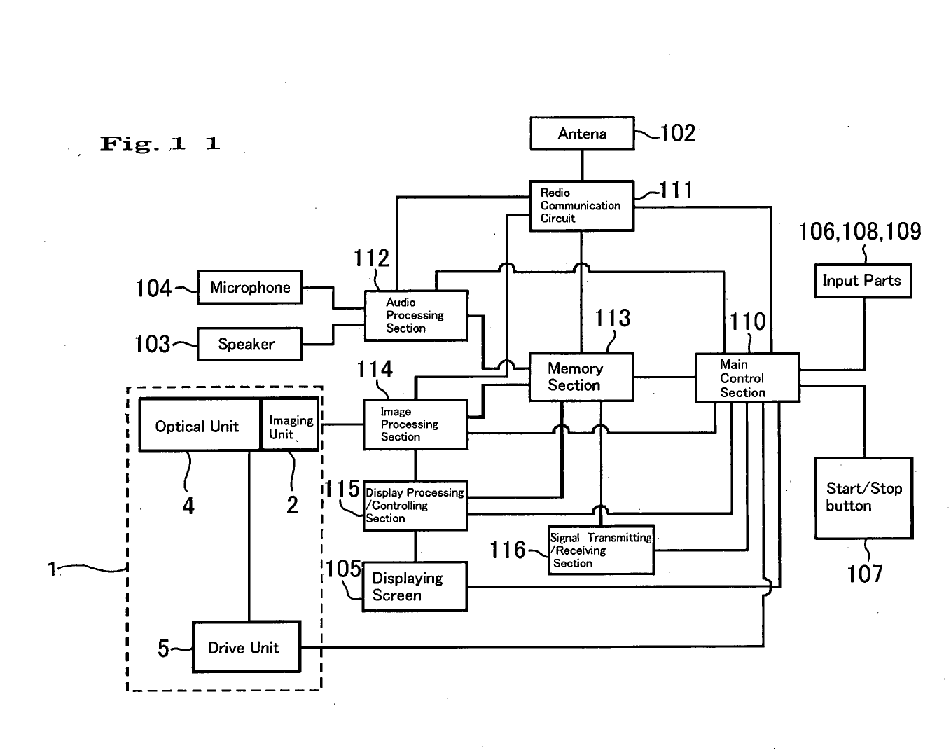

FIGS. 10A, 10B and 10C are a front view, right side view, partly in section, and back side view, respectively, of a mobile phone with a built-in camera 100. The mobile phone with a built-in camera 100 has a same construction as a typical mobile phone. The mobile phone 100 has a case 101 having a shape of long plate and a antenna 102. In the upper portion of the front surface of the case 101 is provided a speaker 103, while in the lower portion of the front surface is provided a microphone 104. On the front surface of the case 101 are disposed a display screen 105 employing, for example, liquid crystal, a calling button 106 used for transmission operation, a start/stop button 107 used for operation of power on/off, termination of call and so on, and dial operating buttons 108 used for input of telephone number and so on.

In the mobile phone 100, the imaging device 1 of the aforementioned first embodiment is provided so that the lens 16 is exposed on the back surface of the case 101. The lens 16 of the imaging device 1 can be moved so that focuses can be adjusted with respect to far and near subjects, whereby the mobile phone 100 has two photography modes, i.e., a normal mode for far distance (normal distance) photography and a macro mode for near distance photography. Operation of a photography mode selector button 109 allows the photography modes to be selected to change focusing condition. In stead of the imaging device 1, any of the imaging devices 1′and 1″ of the other aforementioned variations can be used.

FIG. 11 is a functional block diagram illustrating a construction of control system of the mobile phone 100. The mobile phone 100 has a main control section 110 for controlling the overall control system. To the main control section 110 are connected a radio communication circuit 111, an audio processing section 112, a memory section 113, an image processing section 114, a display processing/controlling section 115, a signal transmitting/receiving section 116, the displaying screen 105, the drive unit 5, input parts 106, 108 and 109, and a start/stop button 107. The radio communication circuit 111 is connected to the antenna 102, the audio processing section 112 and the memory section 113. To the audio processing section 112 are connected the microphone 104 and the speaker 103. To the memory section 113 are connected the signal transmitting/receiving section 116 and the display processing/controlling section 115. To the image processing section 114 is connected the imaging unit 2 of the imaging device 1. The display processing/controlling section 115 is connected to the image processing section 114 and the displaying screen 105.

A signal received by the antenna 102 is demodulated at the radio communication circuit 111. An audio data is transmitted to the audio processing section 112 and an image data is transmitted to the image processing section. 114. The main control section 110 allows the audio data and the image data to be outputted to the memory section 113 and stored if necessary. The audio processing section 112 processes the audio data to generate a audio signal and output it to the speaker 104. The image processing section 114 decompresses the image data to send it to the display processing/controlling section 115. The display processing/controlling section 115 adds a necessary image signal or character signal to the received image via a command from the main control section 110 and displays the received image on the displaying screen 105.

An audio signal inputted from the microphone 104 is processed at the audio processing section 112 and sent to the radio communication circuit 111. The radio communication circuit 111 modulates the audio signal to transmit it through the antenna 102.

An image data made at the imaging device 1 is sent to the image processing section 114. The image processing section 114 compresses the image data to send it both to the memory section 113 and the radio communication circuit 111. The radio communication circuit 111 modulates the image signal to transmit it through the antenna 102. The image processing section 114 sends the image date before compressed to the display processing/controlling section 115 which in turn gives the image data a necessary process to output it on the displaying screen 105 so that the image data can be monitored.

The data stored in the memory section 113, if necessary, can be processed to output through the speaker 103, display on displaying screen 105 or transmit through the antenna 102.

In order to change the focusing condition, operation of the photography mode selector button 109 allows the main control section 110 to send control signal to the drive unit 5 to move the optical unit 4 in accordance with the selected photography mode.

Although the present invention has been fully described by way of the examples with reference to the accompanying drawing, it is to be noted that various changes and modifications will be apparent to those skilled in the art. Therefore, unless such changes and modifications otherwise depart from the spirit and scope of the present invention, they should be construed as being included therein.

1. An imaging device comprising:
an imaging unit having a photoelectric converter for converting an optical image into electric signal;
an optical unit for forming an optical image of a subject on the photoelectric converter, the optical unit comprising a lens and a lens frame which supports the lens and has a hanger shaft hole;
a chassis on which the imaging unit is mounted and a hanger shaft is integrally formed, the hanger shaft being fit into the hanger shaft hole to support the lens frame so that the lens frame is capable of moving in an optical axis direction; and
a drive unit for actuating the lens frame of the optical unit in the optical axis direction, and wherein the hanger shaft has a plurality of diameters so that the chassis side of the hanger shaft is largest and the side apart from the chassis becomes small, and
wherein the hanger shaft hole has a plurality of diameters which fit to the hanger shaft.

2. An imaging device as claimed in claim 1, wherein the hanger shaft has a first diameter and a second diameter smaller than the first diameter, and
wherein the hanger shaft hole has a third diameter that fits to the first diameter of the hanger shaft and a fourth diameter that is smaller than the third diameter and fits to the second diameter of the hanger shaft.

3. An imaging device as claimed in claim 1, wherein the hanger shaft has a taper between portions having different diameters.

4. An imaging device as claimed in claim 3, wherein the hanger shaft hole has a taper between portions having different diameters.

5. An imaging device as claimed in claim 1, wherein the hanger shaft has a step between portions having different diameters.

6. An imaging device as claimed in claim 5, wherein the hanger shaft hole has a step between portions having different diameters.

7. An imaging device as claimed in claim 2, wherein the hanger shaft has a fifth diameter between portions having the first diameter and the second diameter, and wherein the fifth diameter is smaller than the first diameter and larger than the second diameter.

8. An imaging device as claimed in claim 7, wherein the hanger shaft hole has a six diameter between portions having the third diameter and the fourth diameter, and wherein the sixth diameter is smaller than the third diameter and larger than the fourth diameter.

9. An imaging device as claimed in claim 1, wherein the hanger shaft is provided in a projected area of the imaging unit in the optical axis direction.

10. An imaging device as claimed in claim 1, further comprising:
a detector for detecting a position of at least part of the optical unit with respect to the optical axis direction, and
wherein at least either of the drive unit and the detector are provided in a projected area of the imaging unit in the optical axis direction.

11. An imaging device as claimed in claim 10, wherein the drive unit comprises:
a motor having a drive shaft perpendicular to the optical axis of the optical unit; and
a conversion mechanism for converting a rotational motion of the drive shaft into a linear motion in the optical axis direction.

12. An imaging device as claimed in claim 11, wherein the conversion mechanism comprises:
a driving gear provided on the drive shaft of the motor; and
a cam gear meshing with the driving gear, having a cam surface with which a cam follower formed on an extension of the optical unit is in pressure contact, and having a shaft parallel to the optical axis of the optical unit, and
wherein at least part of the cam gear is provided in the projected area of the imaging unit in the optical axis direction.

13. A portable equipment comprising the imaging device as claimed in claim 1.

14. An imaging device as claimed in claim 13, wherein the hanger shaft has a first diameter and a second diameter smaller than the first diameter, and
wherein the hanger shaft hole has a third diameter that fits to the first diameter of the hanger shaft and a fourth diameter that is smaller than the third diameter and fits to the second diameter of the hanger shaft.

15. An imaging device as claimed in claim 13, wherein the hanger shaft has a taper between portions having different diameters.

16. An imaging device as claimed in claim 15, wherein the hanger shaft hole has a taper between portions having different diameters.

17. An imaging device as claimed in claim 13, wherein the hanger shaft has a step between portions having different diameters.

18. An imaging device as claimed in claim 17, wherein the hanger shaft hole has a step between portions having different diameters.

19. An imaging device as claimed in claim 14, wherein the hanger shaft has a fifth diameter between portions having the first diameter and the second diameter, and wherein the fifth diameter is smaller than the first diameter and larger than the second diameter.

20. An imaging device as claimed in claim 19, wherein the hanger shaft hole has a six diameter between portions having the third diameter and the fourth diameter, and wherein the sixth diameter is smaller than the third diameter and larger than the fourth diameter.

21. An imaging device as claimed in claim 13, wherein the hanger shaft is provided in a projected area of the imaging unit in the optical axis direction.

22. An imaging device as claimed in claim 13, further comprising:
a detector for detecting a position of at least part of the optical unit with respect to the optical axis direction, and
wherein at least either of the drive unit and the detector are provided in a projected area of the imaging unit in the optical axis direction.

23. An imaging device as claimed in claim 22, wherein the drive unit comprises:
a motor having a drive shaft perpendicular to the optical axis of the optical unit; and
a conversion mechanism for converting a rotational motion of the drive shaft into a linear motion in the optical axis direction.

24. An imaging device as claimed in claim 23, wherein the conversion mechanism comprises:
a driving gear provided on the drive shaft of the motor; and
a cam gear meshing with the driving gear, having a cam surface with which a cam follower formed on an extension of the optical unit is in pressure contact, and having a shaft parallel to the optical axis of the optical unit, and
wherein at least part of the cam gear is provided in the projected area of the imaging unit in the optical axis direction.
